(19) United States
(12) Patent Application Publication
(10) Pub. No.: US 2025/0314922 A1
(43) Pub. Date: Oct. 9, 2025

(54) DISPLAY PANEL

(71) Applicant: AUO Corporation, Hsinchu City (TW)

(72) Inventors: Chia-Jung WU, Hsinchu City (TW); Yueh-Chi WU, Hisnchu City (TW); Ti-Kuei YU, Hsinchu City (TW); Ya-Ling HSU, Hsinchu City (TW)

(21) Appl. No.: 18/958,583

(22) Filed: Nov. 25, 2024

(30) Foreign Application Priority Data
Apr. 8, 2024 (TW) 113113007

(51) Int. Cl. G02F 1/1333; G02F 1/1339

(52) U.S. Cl. CPC G02F 1/13336; G02F 1/1339

(57) ABSTRACT

A display panel includes a first substrate, a second substrate, a topography imitating layer, a sealing glue layer and a liquid crystal layer. The first substrate has a first display area and a second display area, in which a plurality of light-emitting diodes (LED) are disposed in the second display area. The second substrate is located on the first substrate. The topography imitating layer is located between the first substrate and the second substrate and has a first portion, in which the first portion of the topography imitating layer is located in the second display area. A height of the topography imitating layer is substantially the same as a height of the LEDs, and the first portion of the topography imitating layer is at least adjacent to a first edge of the first substrate. The sealing glue layer covers the topography imitating layer and the LEDs.

### CROSS-REFERENCE TO RELATED APPLICATION

This application claims priority to Taiwan Application Serial Number 113113007, filed Apr. 8, 2024, which is herein incorporated by reference.

### BACKGROUND

### Field of Invention

The present disclosure relates to a display panel.

### Description of Related Art

In the field of large-size display, large-size splicing is generally achieved by splicing screens. However, although a border of a traditional bistable LCD screen is very narrow, after multiple LCD screens are spliced together, splicing gaps can still be seen, causing image distortion.

In this regard, a general solution is to install micro light-emitting diodes (μLED) at the borders of the LCD screens so that images can also be displayed at the borders to achieve the effect of continuous images. However, such a design will make topography heights of three edges with micro light-emitting diodes different from a topography height of one edge without micro light-emitting diodes. It is impossible to use the same packaging process to seal liquid crystal in the middle of the LCD screen, causing process difficulties.

### SUMMARY

One technical aspect of the present disclosure is a display panel.

According to an embodiment of the present disclosure, a display panel includes a first substrate, a second substrate, a topography imitating layer, a sealing glue layer and a liquid crystal layer. The first substrate has a first display area and a second display area, in which a plurality of light-emitting diodes (LED) are disposed in the second display area. The second display area surrounds the first display area. The second substrate is located on the first substrate. The topography imitating layer is located between the first substrate and the second substrate and has a first portion, in which the first portion of the topography imitating layer is located in the second display area. A height of the topography imitating layer is substantially the same as a height of the light-emitting diodes, and the first portion of the topography imitating layer is at least adjacent to a first edge of the first substrate. The sealing glue layer covers the topography imitating layer and the light-emitting diodes. The liquid crystal layer is located between the first substrate and the second substrate and surrounded by the topography imitating layer and the light-emitting diodes.

According to an embodiment of the present disclosure, the topography imitating layer includes a plurality of blocks, and a shape of each of the blocks is the same as that of one of the light-emitting diodes.

According to an embodiment of the present disclosure, the display panel further includes an optical barrier layer. The optical barrier layer is located between the blocks of the topography imitating layer.

According to an embodiment of the present disclosure, the optical barrier layer is located between the light-emitting diodes.

According to an embodiment of the present disclosure, the topography imitating layer includes a plurality of blocks, and a shape of an outer contour of each of the blocks is the same as that of an outer contour of a pixel defined by three of the light-emitting diodes.

According to an embodiment of the present disclosure, the topography imitating layer includes a plurality of blocks, and a shape of an outer contour of each of the blocks is the same as that of an outer contour of two adjacent pixels defined by a partial number of the light-emitting diodes.

According to an embodiment of the present disclosure, the second display area of the first substrate has a third edge relative to the first edge, and the topography imitating layer further includes a second portion adjacent to the third edge.

According to an embodiment of the present disclosure, the second display area of the first substrate has a second edge and a fourth edge adjacent to the first edge, and the topography imitating layer further includes a third portion adjacent to the second edge or the fourth edge, and the third portion of the topography imitating layer is adjacent to the first portion of the topography imitating layer.

According to an embodiment of the present disclosure, the topography imitating layer further includes a fourth portion located in the first display area, and the fourth portion of the topography imitating layer is adjacent to the first portion of the topography imitating layer.

According to an embodiment of the present disclosure, the topography imitating layer surrounds the light-emitting diodes.

According to an embodiment of the present disclosure, the first edge is adjacent to a bonding area.

According to an embodiment of the present disclosure, the topography imitating layer includes an ultra-high aperture, a photo spacer on array, a black matrix on array, or a combination thereof.

In the above-described embodiments of the present disclosure, since the topography imitating layer is provided on the first edge of the second display area where the light-emitting diodes are not provided, which simulates topography of the light-emitting diodes and fills up the topography height of the light-emitting diodes, when the seal glue layer is coated later, the seal glue layer can reliably seal the middle liquid crystal layer and maintain a size of a gap between the first substrate and the second substrate and maintain the stability of the process.

### BRIEF DESCRIPTION OF THE DRAWINGS

Aspects of the present disclosure are best understood from the following description of implementations when read in conjunction with accompanying figures. Note that in accordance with standard practice in this industry, various features are not drawn to scale. In fact, dimensions of various features may be arbitrarily increased or reduced for clarity of discussion.

FIG. 1 illustrates a top view of a spliced display according to an embodiment of the present disclosure.

FIG. 2 illustrates a top view of a display panel according to an embodiment of the present disclosure.

FIG. 3 illustrates a partial enlarged view of a dotted range A of the display panel in FIG. 2.

FIG. 4 illustrates a cross-sectional view along line 4-4 of the display panel in FIG. 3.

FIG. 5 illustrates a partial enlarged view of a dotted range B of the display panel in FIG. 2.

FIG. 6 illustrates a cross-sectional view along line 6-6 of the display panel in FIG. 5.

FIG. 7 illustrates a partial enlarged view of a display panel near a first edge according to another embodiment of the present disclosure.

FIG. 8 illustrates a partial enlarged view of the display panel in FIG. 7 near a second edge.

FIG. 9 illustrates a partial enlarged view of a display panel near a first edge according to another embodiment of the present disclosure.

FIG. 10 illustrates a partial enlarged view of a display panel near a first edge according to another embodiment of the present disclosure.

FIG. 11 illustrates a top view of a display panel according to an embodiment of the present disclosure.

FIG. 12 illustrates a top view of a display panel according to another embodiment of the present disclosure.

FIG. 13 illustrates a partial enlarged view of a display panel near a first edge according to another embodiment of the present disclosure.

FIG. 14 illustrates a partial enlarged view of the display panel in FIG. 13 near a second edge.

FIG. 15 illustrates a partial enlarged view of a display panel near a second edge according to another embodiment of the present disclosure.

### DETAILED DESCRIPTION

The description of the embodiments disclosed below provides many different embodiments or examples, for implementing various features of the provided subject matter. Specific examples of components and arrangements are described below to simplify the present application. Of course, these examples are examples only and are not intended to be limiting. Additionally, reference symbols and/or letters may be repeated in each example. This repetition is for simplicity and clarity and does not by itself specify a relationship between various embodiments and/or configurations discussed.

Spatially relative terms such as “below”, “beneath”, “lower”, “over”, “upper”, etc. may be used herein for the purpose of convenience of description to describe the relationship of one element or feature to another element or feature as shown in the drawings. Spatially relative terms are intended to encompass different orientations of the device in use or operation in addition to the orientation illustrated in the figures. The device may be otherwise oriented (rotated 90 degrees or at other orientations), and the spatially relative descriptions used herein interpreted accordingly.

As used herein, “about,” “approximately,” or “substantially” includes a stated value and an average within an acceptable deviation range from a particular value as determined by one of ordinary skill in the art, taking into account the measurement discussed and a specific amount of error associated with the measurement (i.e., limitations of the measurement system). For example, “about” may mean within one or more standard deviations of the stated value, or within ±30%, ±20%, ±10%, ±5%. Furthermore, the terms “about”, “approximately”, or “substantially” used herein can be used to select a more acceptable deviation range or standard deviation based on optical properties, etching properties, or other properties, instead of using one standard deviation to apply to all properties.

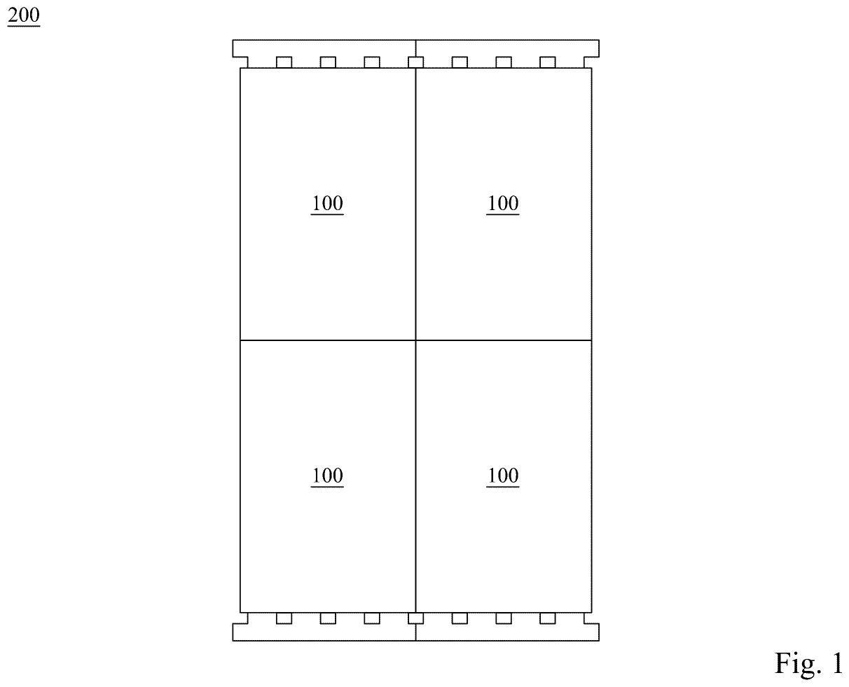

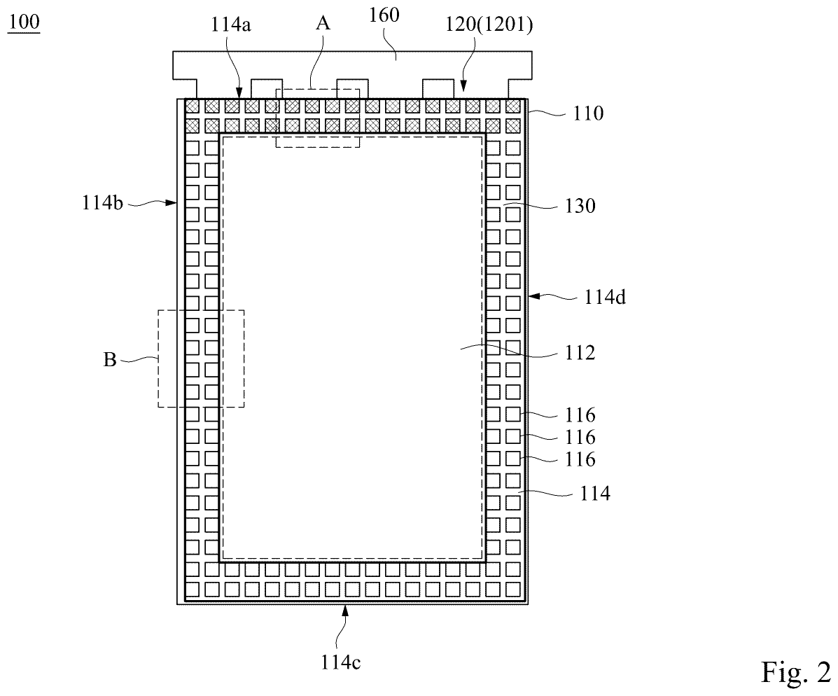

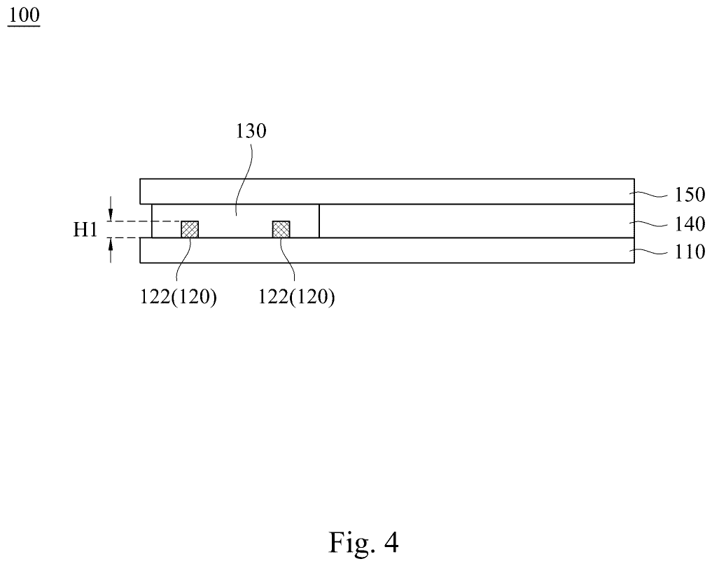

FIG. 1 illustrates a top view of a spliced display 200 according to an embodiment of the present disclosure. FIG. 2 illustrates a top view of a display panel 100 according to an embodiment of the present disclosure. Referring to FIGS. 1 and 2, the display panel 100 may be one of display panels of the spliced display 200. A number of the display panels 100 in FIG. 1 is only for illustration and is not intended to limit the present disclosure. The display panel 100 includes a first substrate 110 and a topography imitating layer 120. In order to clearly express the component configuration of the first substrate 110, FIG. 2 omits a second substrate 150 covering the first substrate 110 (to be described in FIG. 4). The first substrate 110 has a first display area 112 and a second display area 114, in which the second display area 114 is provided with a plurality of pixels 116. The second display area 114 surrounds the first display area 112 and has a first edge 114a, a second edge 114b, a third edge 114c and a fourth edge 114d. The topography imitating layer 120 has a first portion 1201 located in the second display area 114. In this embodiment, the first portion 1201 of the topography imitating layer 120 is adjacent to the first edge 114a of the first substrate 110. The display panel 100 further includes a bonding area 160. In this embodiment, the bonding area 160 is adjacent to the first edge 114a of the second display area 114. Except for the first edge 114a of the second display area 114 adjacent to the bonding area 160, the remaining three edges (i.e., the second edge 114b, the third edge 114c and the fourth edge 114d of the second display area 114) will spliced with other display panels 100. Therefore, the second edge 114b, the third edge 114c, and the fourth edge 114d of the second display area 114 are all provided with light-emitting diodes 116a, 116b and 116c. In the following, the single display panel 100 will be described in detail.

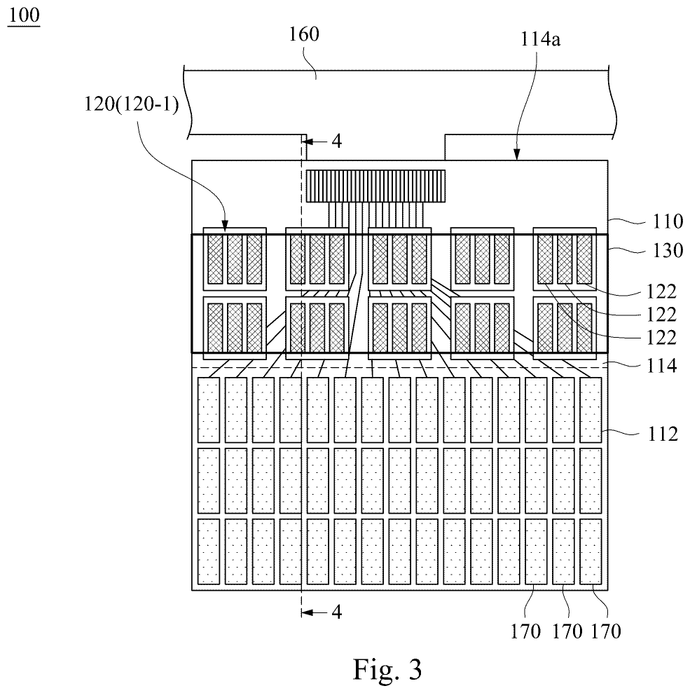

FIG. 3 illustrates a partial enlarged view of a dotted range A of the display panel 100 in FIG. 2. FIG. 4 illustrates a cross-sectional view along line 4-4 of the display panel 100 in FIG. 3. Referring to FIGS. 3 and 4, taking the first edge 114a of the second display area 114 of the display panel 100 as an example, the display panel 100 further includes a second substrate 150, a liquid crystal layer 140 and a seal glue layer 130. The second substrate 150 is located on the first substrate 110. The topography imitating layer 120 is located between the first substrate 110 and the second substrate 150. The seal glue layer 130 covers the topography imitating layer 120. The liquid crystal layer 140 is located between the first substrate 110 and the second substrate 150. The display panel 100 further includes a plurality of liquid crystal pixels 170, and the liquid crystal pixels 170 are located in the first display area 112 of the first substrate 110. In this embodiment, the topography imitating layer 120 includes a plurality of blocks 122. In some embodiments, the topography imitating layer 120 includes an ultra-high aperture (UHA), a photo spacer on array (POA), and a black matrix on array (BOA) or a combination thereof.

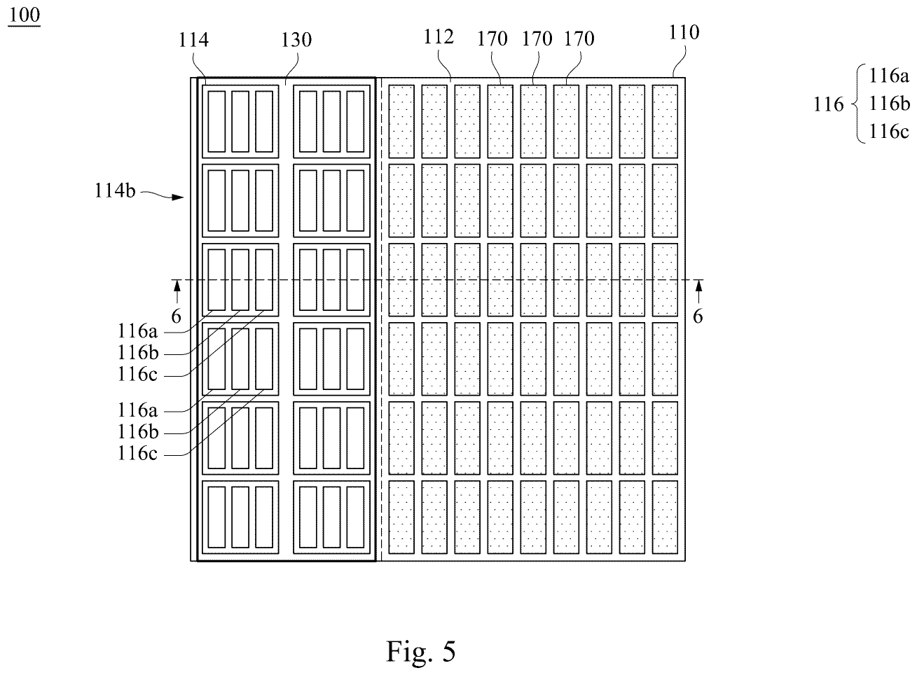

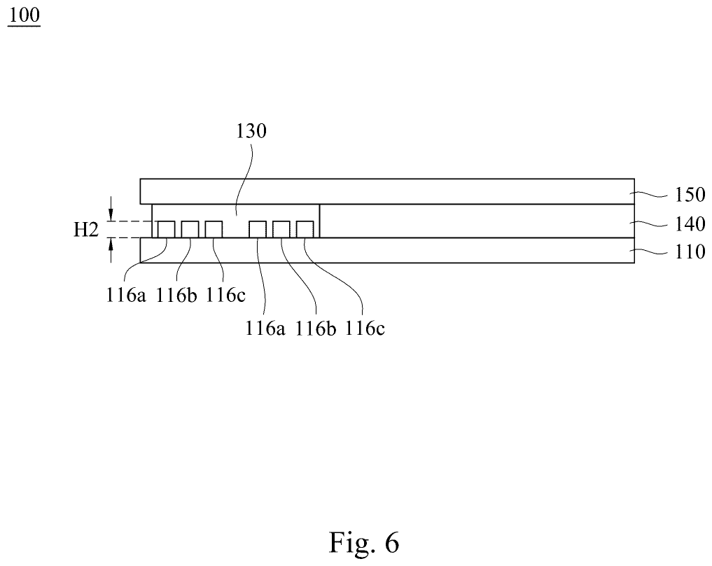

FIG. 5 illustrates a partial enlarged view of a dotted range B of the display panel 100 in FIG. 2. FIG. 6 illustrates a cross-sectional view along line 6-6 of the display panel in FIG. 5. Referring to FIGS. 5 and 6, taking the second edge 114b of the display panel 100 as an example, the seal glue layer 130 covers the light-emitting diodes 116a, 116b and 116c in the second display area 114. Three adjacent light-emitting diodes 116a, 116b and 116c form a pixel 116, and the three light-emitting diodes 116a, 116b and 116c may be a red light-emitting diode, a green light-emitting diode, and a blue light-emitting diode, respectively.

In some embodiments, a shape of each of the blocks 122 of the topography imitating layer 120 in FIG. 3 is the same as that of one of the light-emitting diodes 116a, 116b and 116c. In addition, a height H1 of the topography imitating layer 120 in FIG. 3 is substantially the same as a height H2 of the light-emitting diode 116a.

Since the topography imitating layer 120 is provided on the first edge 114a of the second display area 114 in FIG. 3 where the light-emitting diodes 116a, 116b and 116c are not provided, and the topography imitating layer 120 simulates the topography of the light-emitting diode 116a, 116b and 116c and fills up the topography height of the light-emitting diodes 116a, 116b and 116c, when the seal glue layer 130 is coated later, the seal glue layer 130 can reliably seal the middle liquid crystal layer 140 and maintain a size of a gap between the first substrate 110 and the second substrate 150 and maintain the stability of the process.

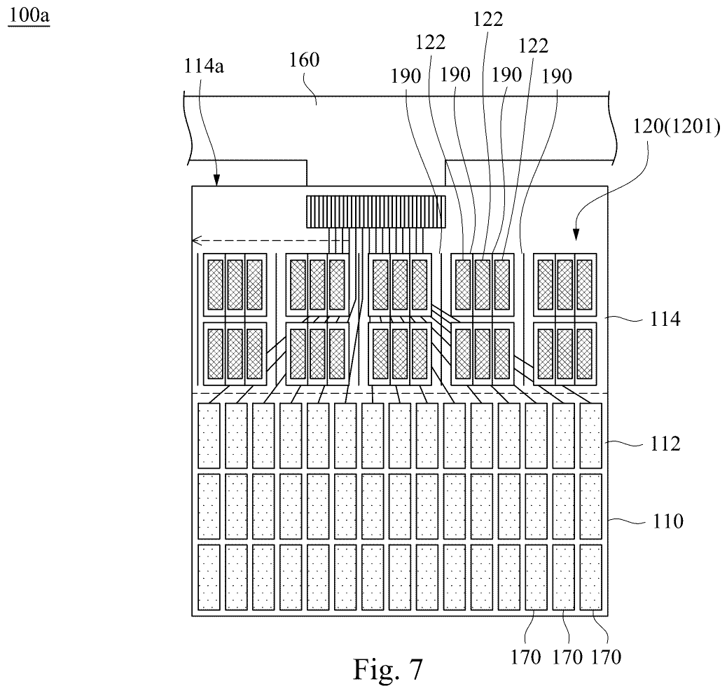

FIG. 7 illustrates a partial enlarged view of a display panel 100a near a first edge 114a according to another embodiment of the present disclosure. Referring to FIG. 7, the display panel 100a includes a first substrate 110 and a topography imitating layer 120. Furthermore, the topography imitating layer 120 includes a plurality of blocks 122. The difference between this embodiment and the embodiment in FIG. 3 is that in this embodiment, the display panel 100 further includes an optical barrier layer 190. The optical barrier layer 190 is located between the blocks 122 of the topography imitating layer 120. A material of the optical barrier layer 190 may include a black matrix, but the disclosure is not limited thereto.

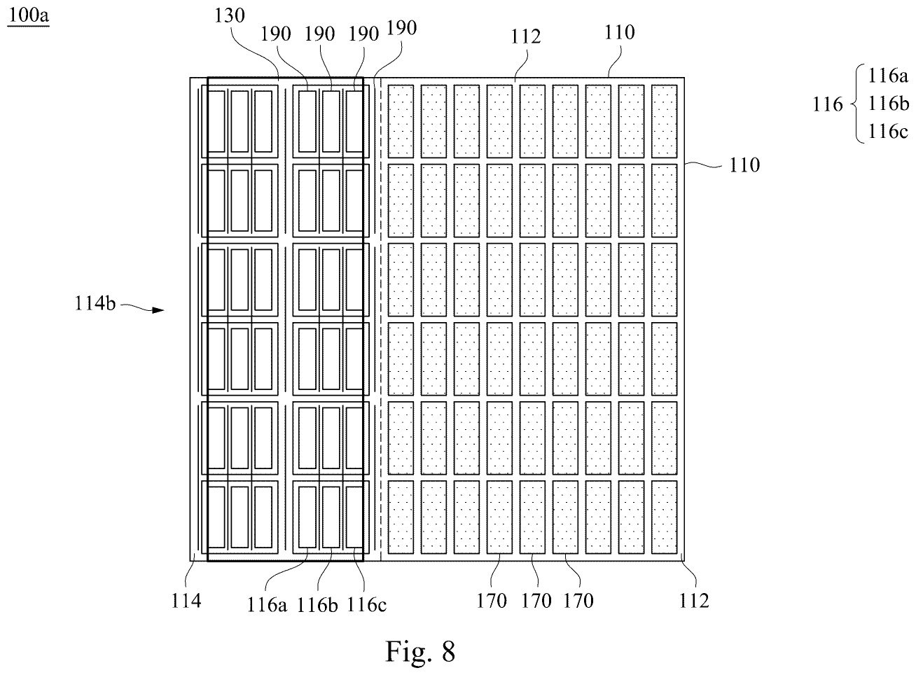

FIG. 8 illustrates a partial enlarged view of the display panel 100a in FIG. 7 near a second edge 114b. Referring to FIG. 8, the difference between this embodiment and the embodiment of FIG. 5 is that in this embodiment, the display panel 100a further includes an optical barrier layer 190. The optical barrier layer 190 can be used to block light. The optical barrier layer 190 is located between two adjacent of the light-emitting diodes 116a, 116b and 116c. A material of the optical barrier layer 190 may include a black matrix or a white matrix, but the disclosure is not limited thereto. For example, in some embodiments, there may be a reflective layer above the optical barrier layer 190.

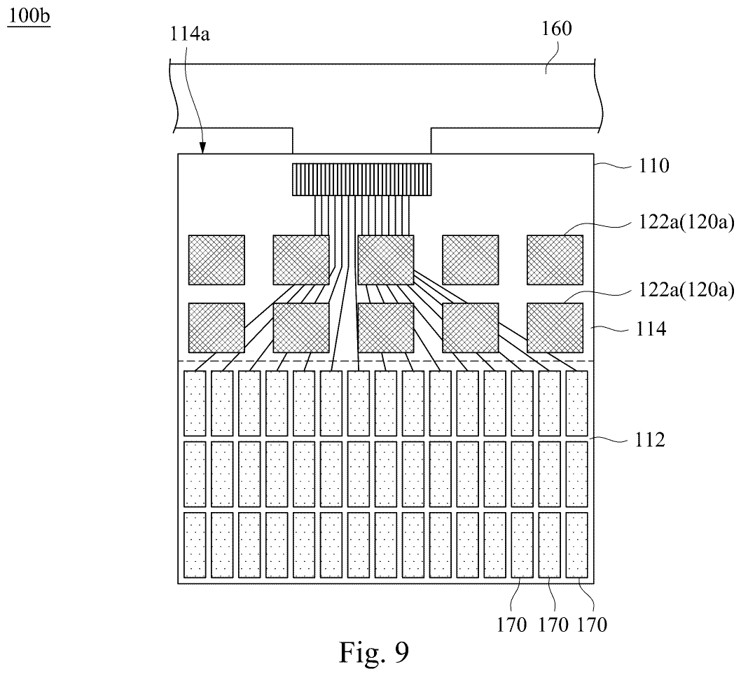

FIG. 9 illustrates a partial enlarged view of a display panel 100b near a first edge 114a according to another embodiment of the present disclosure. Referring to FIG. 9, the display panel 100b includes a first substrate 110 and a topography imitating layer 120a. The difference between this embodiment and the embodiment in FIG. 3 is that in this embodiment, the topography imitating layer 120a includes a plurality of blocks 122a, and a shape of an outer contour of each of the blocks 122a is the same as that of an outer contour of a pixel 116 defined by three adjacent of the light-emitting diodes 116a, 116b and 116c in FIG. 5.

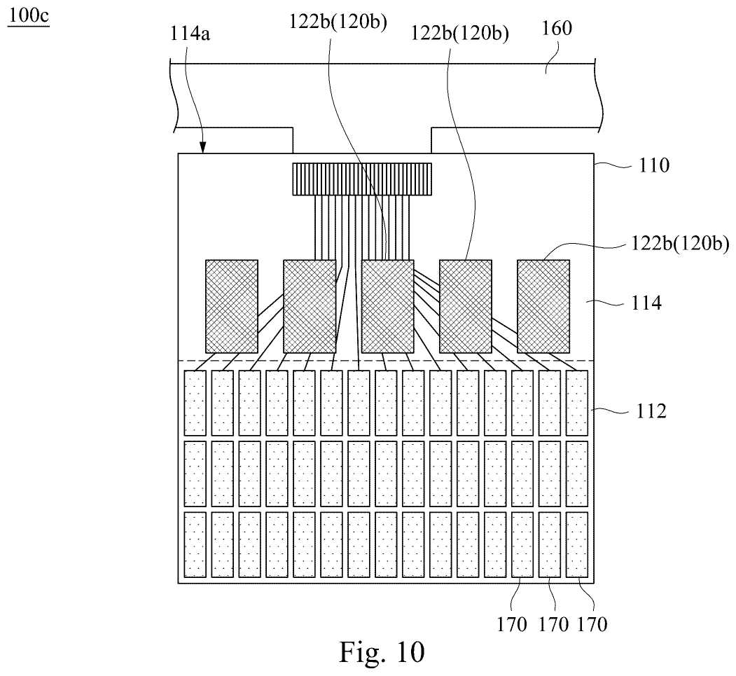

FIG. 10 illustrates a partial enlarged view of a display panel 100c near a first edge 114a according to another embodiment of the present disclosure. Referring to FIG. 10, the display panel 100c includes a first substrate 110 and a topography imitating layer 120b. The difference between this embodiment and the embodiment in FIG. 3 is that in this embodiment, the topography imitating layer 120b has a plurality of blocks 122b, and a shape of an outer contour of each of the blocks 122b is the same as that of an outer contour of two adjacent pixels 116 (e.g., upper and lower adjacent pixels in the leftmost row in FIG. 5) defined by a partial number of the light-emitting diodes 116a, 116b and 116c in FIG. 5.

The above-mentioned blocks 122, blocks 122a and blocks 122b can be selectively applied in the following embodiments.

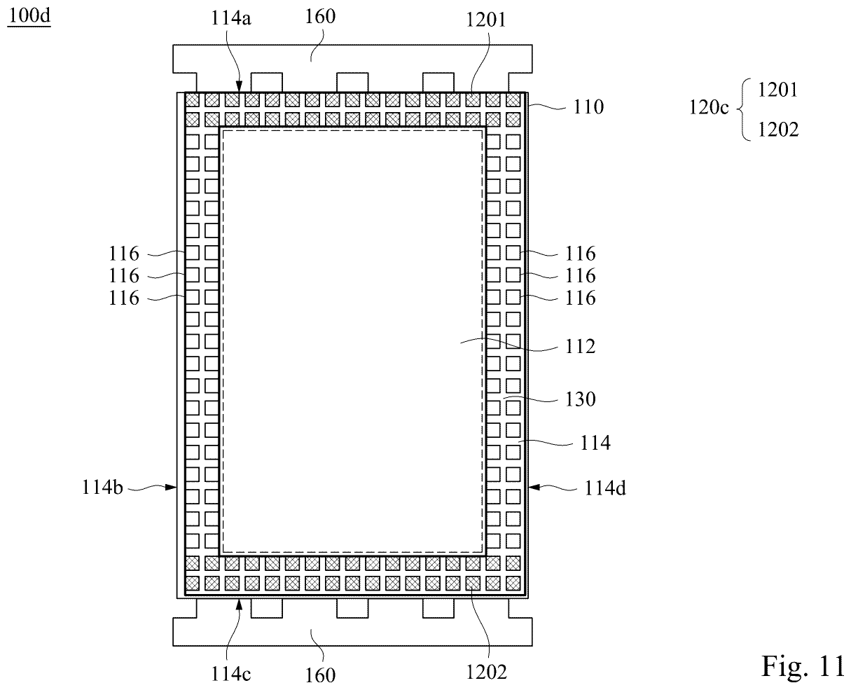

FIG. 11 illustrates a top view of a display panel 100d according to an embodiment of the present disclosure. Referring to FIG. 11, the display panel 100d includes a first substrate 110, a topography imitating layer 120c and a seal glue layer 130. The first substrate 110 has a first display area 112 and a second display area 114, in which the second display area 114 is provided with a plurality of pixels 116. The second display area 114 surrounds the first display area 112. The difference between this embodiment and the embodiment of FIG. 2 is that in this embodiment, the second display area 114 of the first substrate 110 has a third edge 114c relative to the first edge 114a, and the topography imitating layer 120c further includes a second portion 1202 adjacent to the third edge 114c. Such a design can be applied to a display in which only the second edge 114b and the fourth edge 114d need to be spliced with other display panels (not shown). That is, the first edge 114a and the third edge 114c of the display panel 100d are adjacent to bonding areas 160, respectively.

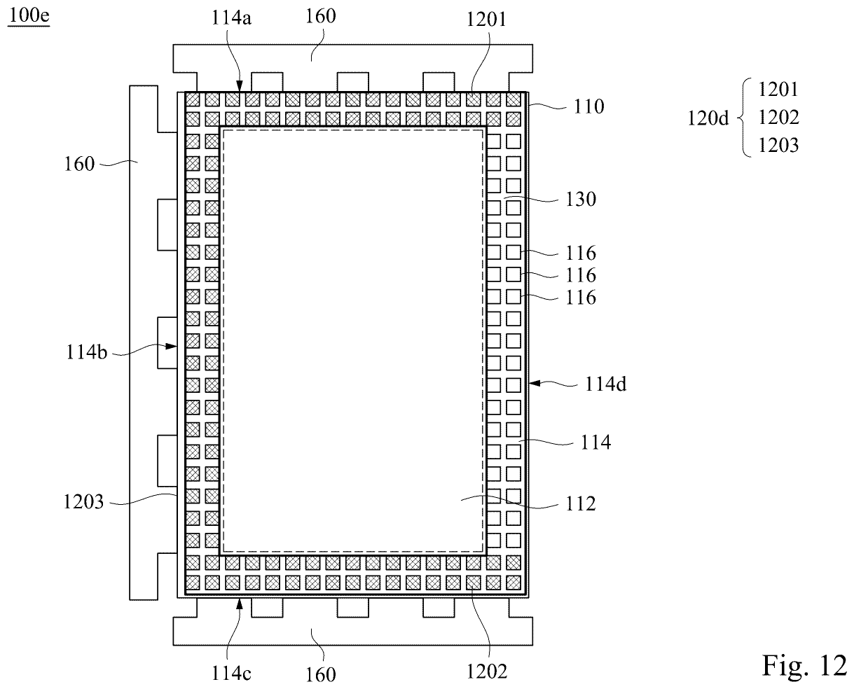

FIG. 12 illustrates a top view of a display panel 100e according to another embodiment of the present disclosure. Referring to FIG. 12, the display panel 100e includes a first substrate 110, a topography imitating layer 120d and a seal glue layer 130. The first substrate 110 has a first display area 112 and a second display area 114, in which the second display area 114 is provided with a plurality of pixels 116. The second display area 114 surrounds the first display area 112. The difference between this embodiment and the embodiment of FIG. 2 is that in this embodiment, the second display area 114 of the first substrate 110 has a second edge 114b and a fourth edge 114d adjacent to the first edge 114a. The topography imitating layer 120d further includes a third portion 1203 adjacent to the second edge 114b or the fourth edge 114d. Taking the topography imitating layer 120d adjacent to the second edge 114b in FIG. 12 as an example, the third portion 1203 of the topography imitating layer 120d is adjacent to the first portion 1201 and the second part 1202 of the topography imitating layer 120d. Such a design can be applied to a display in which only one edge (e.g., the fourth edge 114d) needs to be spliced with another display panel (not shown).

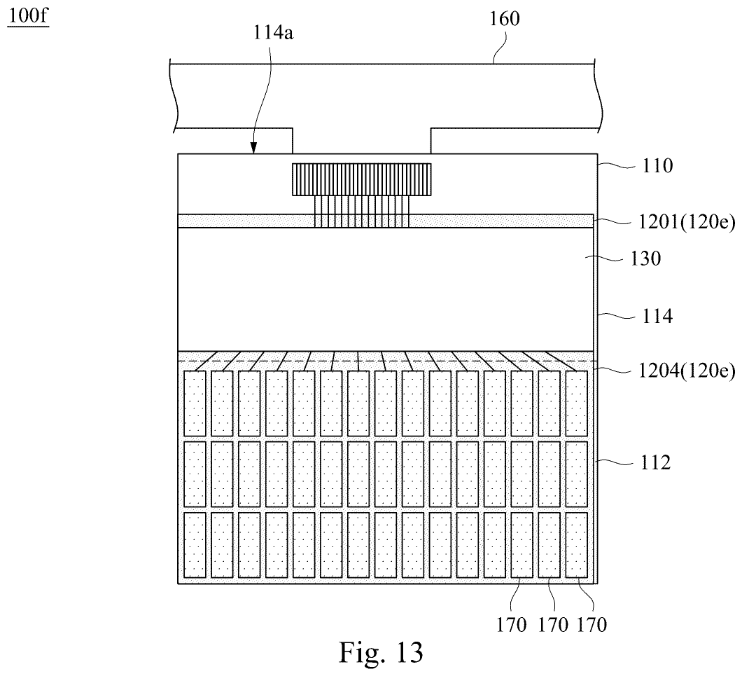

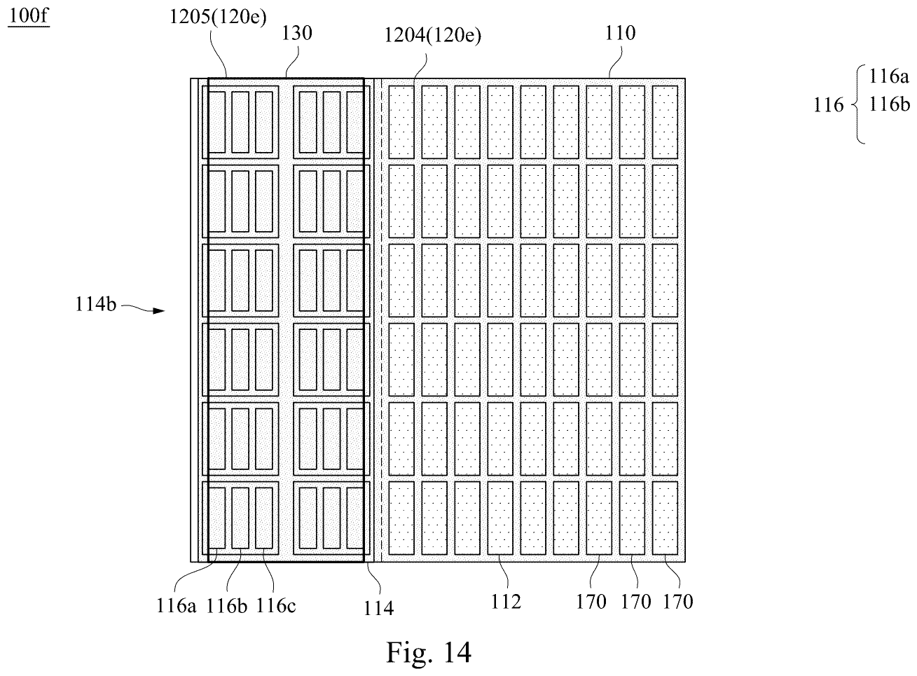

FIG. 13 illustrates a partial enlarged view of a display panel 100f near a first edge 114a according to another embodiment of the present disclosure. FIG. 14 illustrates a partial enlarged view of the display panel 100f in FIG. 13 near a second edge 114b. Referring to FIGS. 13 and 14, the display panel 100f includes a first substrate 110, a topography imitating layer 120e and a seal glue layer 130. The difference between this embodiment and the embodiments in FIGS. 3 and 5 is that in this embodiment, the topography imitating layer 120e further includes a fourth portion 1204 located in the first display area 112, and the fourth portion 1204 of the topography imitating layer 120e is adjacent to the first portion 1201 of the topography imitating layer 120e. Furthermore, the topography imitating layer 120e has a fifth portion 1205 surrounding the light-emitting diodes 116a, 116b and 116c. That is, in this embodiment, an entire surface of the first substrate 110 of the display panel 100f is coated with the topography imitating layer 120e to achieve the requirement of flattening the topography.

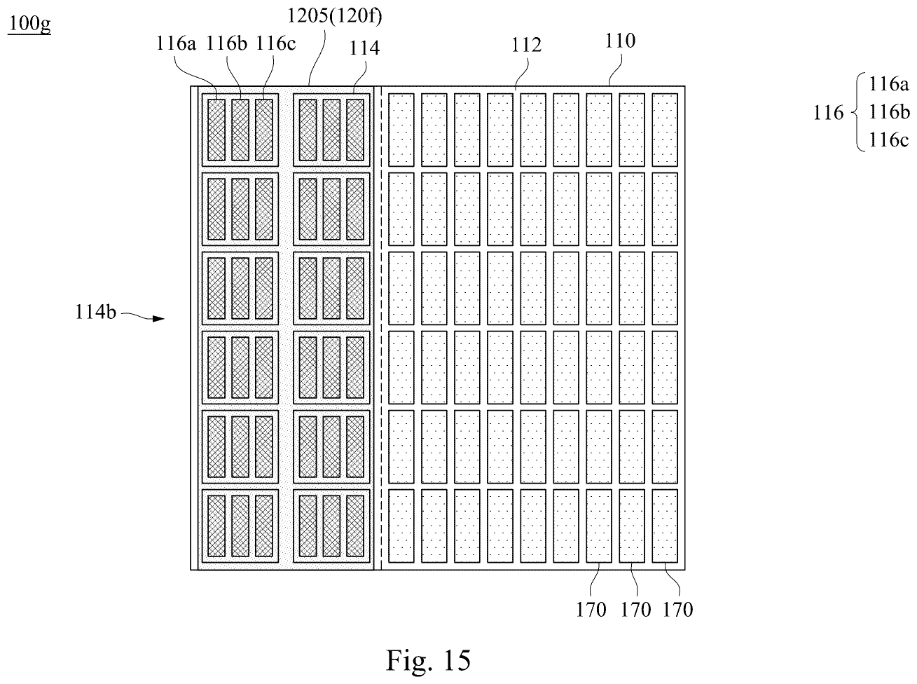

FIG. 15 illustrates a partial enlarged view of a display panel 100g near a second edge 114b according to another embodiment of the present disclosure. Referring to FIG. 15, the display panel 100g includes a first substrate 110 and a topography imitating layer 120f. The difference between this embodiment and the embodiment in FIG. 14 is that in this embodiment, the topography imitating layer 120f does not have the fourth portion 1204 located in the first display area 112 in FIG. 14. The fifth portion 1205 of the topography imitating layer 120f surrounds the light-emitting diodes 116a, 116b and 116c.

The foregoing summarizes the features of several embodiments so that those skilled in the art can better understand aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also recognize that such equivalent constructions do not depart from the spirit and scope of the present disclosure, and that those can be variously changed, substituted, and altered herein without departing from the spirit and scope of the present disclosure.

What is claimed is:

1. A display panel, comprising:
a first substrate, having a first display area and a second display area, wherein a plurality of light-emitting diodes are disposed in the second display area, and the second display area surrounds the first display area;
a second substrate, located on the first substrate;
a topography imitating layer, located between the first substrate and the second substrate and having a first portion, wherein the first portion of the topography imitating layer is located in the second display area, and a height of the topography imitating layer is substantially the same as a height of the light-emitting diodes, and the first portion of the topography imitating layer is at least adjacent to a first edge of the first substrate;
a sealing glue layer, covering the topography imitating layer and the light-emitting diodes; and
a liquid crystal layer, located between the first substrate and the second substrate and surrounded by the topography imitating layer and the light-emitting diodes.

2. The display panel of claim 1, wherein the topography imitating layer comprises a plurality of blocks, and a shape of each of the blocks is the same as that of one of the light-emitting diodes.

3. The display panel of claim 2, further comprising:
an optical barrier layer, located between the blocks of the topography imitating layer.

4. The display panel of claim 3, wherein the optical barrier layer is located between the light-emitting diodes.

5. The display panel of claim 1, wherein the topography imitating layer comprises a plurality of blocks, and a shape of an outer contour of each of the blocks is the same as that of an outer contour of a pixel defined by three of the light-emitting diodes.

6. The display panel of claim 1, wherein the topography imitating layer comprises a plurality of blocks, and a shape of an outer contour of each of the blocks is the same as that of an outer contour of two adjacent pixels defined by a partial number of the light-emitting diodes.

7. The display panel of claim 1, wherein the second display area of the first substrate has a third edge relative to the first edge, and the topography imitating layer further comprises a second portion adjacent to the third edge.

8. The display panel of claim 1, wherein the second display area of the first substrate has a second edge and a fourth edge adjacent to the first edge, and the topography imitating layer further comprises a third portion adjacent to the second edge or the fourth edge, and the third portion of the topography imitating layer is adjacent to the first portion of the topography imitating layer.

9. The display panel of claim 1, wherein the topography imitating layer further comprises a fourth portion located in the first display area, and the fourth portion of the topography imitating layer is adjacent to the first portion of the topography imitating layer.

10. The display panel of claim 1, wherein the topography imitating layer surrounds the light-emitting diodes.

11. The display panel of claim 1, wherein the first edge is adjacent to a bonding area.

12. The display panel of claim 1, wherein the topography imitating layer comprises an ultra-high aperture, a photo spacer on array, a black matrix on array, or a combination thereof.

13. A display panel, comprising:
a substrate, having a first display area and a second display area, wherein a plurality of light-emitting diodes are disposed in the second display area, and the second display area surrounds the first display area;
a topography imitating layer, located on the substrate and having a first portion, wherein the first portion of the topography imitating layer is located in the second display area, and a height of the topography imitating layer is substantially the same as a height of the light-emitting diodes, and the first portion of the topography imitating layer is at least adjacent to a first edge of the substrate;
a sealing glue layer, covering the topography imitating layer and the light-emitting diodes; and
a liquid crystal layer, located on the substrate and surrounded by the topography imitating layer and the light-emitting diodes.

14. The display panel of claim 13, wherein the topography imitating layer comprises a plurality of blocks, and a shape of each of the blocks is the same as that of one of the light-emitting diodes.

15. The display panel of claim 14, further comprising:
an optical barrier layer, located between the blocks of the topography imitating layer.
